(19) United States
(12) Patent Application Publication
(10) Pub. No.: US 2021/0232884 A1
(43) Pub. Date: Jul. 29, 2021

(54) CAPACITIVE INFORMATION CARRIER WITH IMPROVED DETECTION ACCURACY BY MEANS OF A VIA AND METHOD FOR THE MANUFACTURE THEREOF

(71) Applicant: Touchcode Technologies, LLC, New York, NY (US)

(72) Inventors: Matthias Foerster, Dresden (DE); Sascha Voigt, Bernsdorf (DE); Jan Thiele, Chemnitz (DE); Karin Weigelt, Chemnitz (DE)

(73) Assignee: Touchcode Technologies, LLC, New York, NY (US)

(21) Appl. No.: 17/063,023

(22) Filed: Oct. 5, 2020

Related U.S. Application Data
(63) Continuation of application No. 15/516,158, filed on Mar. 31, 2017, now abandoned.

(30) Foreign Application Priority Data
Oct. 2, 2014 (EP) 14187489.1

(51) Int. Cl. G06K 19/07; G06K 19/067; G06K 1/12

(52) U.S. Cl. CPC G06K 19/0723; G06K 1/121; G06K 19/067

(57) ABSTRACT

The present invention relates to a capacitive, planar information carrier wherein vias form an electrical and/or galvanic connection between sub-areas of a first electrically conductive area being part of an electrically conductive layer on one side of the information carrier and an electrically conductive pattern on the other side of the information carrier. In another aspect, the invention relates to a method for the manufacture of an information carrier.

The present invention relates to a capacitive, planar information carrier wherein vias form an electrical and/or galvanic connection between elements of an electrically conductive layer on one side of the information carrier and an electrically conductive pattern on the other side of the information carrier. In another aspect, the invention relates a method for the manufacture of an information carrier.

### BACKGROUND OF THE INVENTION

During the last years, there has been a rapid development for devices capable of storing information which additionally interact with touch screens. A touch screen is in particular a physical interface for sensing electrical capacitances or capacitance differences within subareas of a defined area. These touch screens are common in (but not limited to) smart phones, mobile phones, displays, tablet-PCs, tablet notebooks, graphic tablets, television devices, trackpads, touchpads, input devices, PDAs, and/or MP3 devices. Technologies to perform this detection include resistive, capacitive, acoustic and optical technologies. All these technologies are optimized to detect a human finger or a specially designed stylus that is brought into contact with a touch screen.

The prior art shows several ways of producing, with the aid of printing techniques or other coating processes, information carriers that can be read by smart devices. A commonly used approach is to apply a bar code or a QR code on any kind of object. These bar codes can be sensed by suitable optic scanners or cameras which are often part of the devices including a touch screen. Although easy and economically to produce, bar codes have some disadvantageous, e.g. the fact that it is easy to generate a counterfeit by just copying the bar code. Thus, they are less safe than more sophisticated information storing devices. Furthermore, it may not be desirable for certain applications that the bar code covers a certain area of the object where the code is applied to and that it is visible to a user.

In US 2007/0164414 A1 a wireless IC device is disclosed which includes a radiation pattern for radiating a transmission signal supplied from a power supply circuit.

Particularly, the IC device is configured to be used in an RFID (Radio Frequency Identification) system. In US 2007/0164414 A1, the power supply circuit board is obtained by layering ceramic sheets that are formed from a dielectric member wherein the radiating of transmission signal depends on the availability of sufficient power for the radiation pattern. In US 2007/0164414 A1, information is transmitted only if the device is connected to an external power supply.

In US 2013/0069908 A1 a capacitive card for a capacitive touch screen is disclosed. The card has a substrate and a capacitive layer including multiple capacitive electrode areas and at least one circuit connected with the capacitive electrode areas. The capacitive electrode areas may be activated by the touch of a finger, so that a touch screen can read the configuration of the activated capacitive electrode areas. In the context of US 2013/0069908 A1, the configuration of the capacitive electrode areas itself causes a specific program to be executed on a smart phone device.

In a specific embodiment of US 2013/0069908 A1, the card may comprise an aperture having an electrically conductive inner surface. By this conductive connection between a capacitive sheet on one side of the card and the capacitive electrode areas on the other side of the card, it is made possible to activate the capacitive electrode areas by touching the capacitive sheet on the opposite side of the card. Consequently, the aperture is not used in order to differentiate the impact of different areas of the capacitive electrode areas, but to enable the activation of these capacitive electrode areas from the opposite side of the card. Thus, it is not possible in the context of US 2013/0069908 A1 to emphasize the impact of certain parts of the capacitive electrode areas in relation to other parts of the capacitive electrode areas. Instead, the capacitive electrode areas and the at least one circuit have exactly the same impact on a capacitive touch screen.

EP 2 722 739 A1 discloses a system comprising a card and a device comprising a touch sensor. The card comprises one or more visual card marks indicative for actions detectable by the touch sensor wherein the actions have to be performed to enable identification of the card by the device with the touch sensor. However, the visual marks are located on one side of the card, in other words, they are arranged within a single plane lying parallel to the surface of the touch sensor. Thus, EP 2 722 739 A1 discloses that the visual marks have the same distance to the touch sensor and the same impact on the touch sensor.

In WO 2011/154524 A1, a system for the transfer of information is disclosed. This system comprises a capacitive information carrier and a surface sensor. The basic idea of the system is to use an information carrier comprising a pattern of electrically conductive regions placed on a non-conductive substrate by printing. This pattern is referred to as a touch structure. As the touch screen technology is optimized to detect a human finger or a specially designed stylus that is brought into contact with a touch screen, this touch structure alms at imitating the properties and the arrangement of fingertips.

Furthermore, the invention comprises a process for acquiring information, comprising a capacitive information carrier, a capacitive surface sensor, a contact between the two elements, and an interaction which makes a touch structure of the information carrier evaluable for a data-processing system connected to the surface sensor and can trigger events that are associated with the information carrier.

According to WO 2011/154524 A1, the information carrier has at least one electrically conductive layer arranged on an electrically non-conductive substrate. An interaction between the information carrier and the capacitive surface sensor is achieved by bringing into contact the capacitive surface sensor and the information carrier. It is preferred that the contact is a static and/or dynamic contact. In the context of WO 2011/154524 A1, an information carrier is in particular a medium for the storage, replication, deposition and/or assignment of information.

The capacitive information carrier of the WO 2011/154524 A1 comprises at least one electrically conductive layer, which is arranged as a touch structure on an electrically non-conductive substrate. The touch structure comprises of at least one coupling surface which is connected to at least one touch point via at least one conductive trace.

The combination of at least one or more touch points in a touch structure replicates the arrangement or properties of fingertips, wherein the property of the touch structure is described to the effect that said touch structure can execute an input on a surface sensor just like one or multiple fingers. Such a structure can be evaluated by a data-processing system connected to the surface sensor and processed by software technology. The system described in WO 2011/154524 A1 allows for detecting the information carrier by means of a surface sensor capacitively.

The arrangement of at least one electrically conductive layer as a touch structure on an electrically non-conductive substrate which comprises at least one touch point, a coupling surface and/or a conductive trace gives a certain level of reproducibility and recognition precision throughout the whole recognition process. The detection precision, i.e. the relative position of touch points detected by the data-processing system compared to the physical relative position of the touch points on the capacitive information carrier, is limited. These limitations are due to the nature of capacitive reading. Not only the conductive areas representing the touch points cause a change in capacitance on the capacitive surface sensor, but also the conductive traces. Whereas the detection of the touch points is the desired effect of the invention described in WO 2011/154524 A1, the presence of the coupling surface and the conductive traces in particular is necessary for the functionality of the touch structure, but interfering in the detection process. The geometry of the conductive traces, i.e. their size and area, is designed in that way that these conductive traces will not trigger events by themselves, but the conductive traces shift the center of the touch points detected by the capacitive surface sensor. This causes slight deviations of the relative positions of the touch points detected by the touch screen compared to the physical relative position on the information carrier. These deviations have to be taken into account when setting the tolerances or minimal distances between similar touch structures.

In the context of WO 2011/154524 A1, the conductive elements forming a touch structure can be put into two groups corresponding to their function, the touch points representing a first group and the coupling surface and the conductive traces representing a second group. The purpose of the touch points is to trigger events on the surface sensor therefore representing the conductive elements whose detection is desired in the context of WO 2011/154524 A1. These touch points will be referred to as desired elements in the context of the present application. The coupling surface and the conductive traces represent necessary, but interfering elements whose detection is not desired, but causes the deviations mentioned above. The purpose of the coupling surface is to couple in the user's body capacitance. The purpose of the conductive traces is to galvanically connect the touch points among each other or with the coupling surface. Thus, these elements are needed for functionality reasons, but they are not supposed to interact with the touch screen themselves. It would be appreciated by a person skilled in the art, if these necessary, but interfering elements did not influence the detection process of the desired elements, i.e. the touch points, or if the capacitive impact of the necessary, but interfering elements on the touch screen was reduced significantly compared to the impact of the touch points. In the context of the present application, the difference in capacitance between the desired elements, i.e. the touch points, and the necessary, but interfering elements, i.e. the coupling area and the conductive traces, is referred to as capacitive contrast.

The object of the invention consists in providing an information carrier with enhanced capacitive contrast between the desired elements on the one hand and the necessary, but interfering elements on the other hand which overcomes the disadvantageous and drawbacks of the information carrier known from the prior art. In other words, it is the object of the present invention to emphasize the impact of certain parts of the electrically conductive layer in relation to other parts of the electrically conductive layer. It is a further object of the invention to encode information within the electrically conductive layer which can be transmitted to a touch screen without the need of providing the capacitive, planar information carrier with a separate power supply unit. Furthermore, it Is an object of the present invention to provide an information carrier which is easy and flexible to handle and can be detected with high accuracy and sharp distinctiveness between the desired elements and the necessary, but interfering elements. The object is achieved by the independent claims. Advantageous embodiments result from the dependent claims.

### SUMMARY OF THE INVENTION

The present invention relates to a capacitive, planar information carrier, comprising an electrically non-conductive substrate, an electrically conductive pattern on a back side of the information carrier and a first, second and third electrically conductive area forming an electrically conductive layer on a front side of the information carrier, wherein the electrically conductive pattern and the first, second and third electrically conductive area are formed from at least one sub-area respectively, wherein information is encoded by characteristic features of the first electrically conductive area, said information being copied to the electrically conductive pattern by a congruent or substantially congruent arrangement of the electrically conductive pattern and the first electrically conductive area, wherein at least one sub-area of the first electrically conductive area and at least one sub-area of the electrically conductive pattern are galvanically connected by at least one via comprising a bore hole, wherein the information is detectable by a capacitive touch screen, if the information carrier faces the touch screen with its back side.

In other words, the present invention relates to a capacitive, planar information carrier with a front and a back side. A preferred information carrier has an electrically non-conductive substrate and comprises electrically conductive areas which will, in the context of the invention, be described as first, second and third electrically conductive area. Furthermore, the information carrier comprises an electrically conductive pattern arranged on the back side of the information carrier. This pattern consists of several elliptical, electrically conductive sub-areas which are spread on the back side of the information carrier. This pattern represents the entirety of the elliptical, electrically conductive sub-areas present on the B-side, i.e. the back side, of the information carrier.

It is preferred that the front side of the information carrier can be referred to as A-side and the back side of the information carrier can be referred to as B-side of the information carrier. The corresponding expressions are used synonymously in the description of the present invention. It is preferred that the first, second and third electrically conductive areas are placed on the front side of the information carrier. Preferably, the sub-areas of the first electrically conductive area on the front side of the information carrier and the sub-areas of the electrically conductive pattern on the back side of the information carrier are arranged congruently or substantially congruently.

In the sense of the present invention, two areas are congruent if they have the same shape, size and orientation and are placed at the same position on the front and the back side of the information carrier. If the substrate of the information carrier was transparent and one looked through it, the first area and the sub areas of the pattern would shade and cover exactly the same sector of the substrate.

In the sense of the present invention, the term “substantially congruent” means that two sub-areas share the same geometric center of area, but that they may vary slightly in size and/or shape. The case of substantially congruent sub-areas may arise when for example the sub-areas forming the pattern on the back side of the information carrier are not necessarily elliptical, but represent graphic designs such as flowers, clouds, stars, hearts, biscuits, doughnuts and all kind of circular-like shapes. The sub-areas of the first electrically area and the sub-areas of the electrically conductive pattern preferably share their geometric centers of area and a sufficiently large area where the vias can be applied. It is noted that the terms “center of gravity” and “center of area” will be used synonymously in the context of this application.

The first electrically conductive area is formed from sub-areas which are arranged on the front side of the substrate of the information carrier. It is preferred that these sub-areas may synonymously be referred to as touch points. It is preferred that the touch points are connected by at least one via to the sub-areas of the electrically conductive pattern. In the context of the present invention, it is preferred that the first electrically conductive area and the electrically conductive pattern are referred to as congruent or substantially congruent. It is also preferred that single sub-areas of the first electrically conductive are, i.e. the touch points, and the sub-areas of the electrically conductive pattern which they are directly connected to by the at least one via are referred to as congruent or substantially congruent. Preferably, one touch point is connected to the one congruent or substantially congruent sub-area belonging to the electrically conductive pattern.

In a preferred embodiment of the present invention, the characteristic features by which the information is encoded are selected from a group comprising an overall shape of the first electrically conductive area and/or the electrically conductive pattern, the distance of the sub-areas of the first electrically conductive area and/or sub-areas of the electrically conductive pattern to each other, the allocation of the sub-areas within the first electrically conductive area and/or the electrically conductive pattern and/or the number of sub-areas forming the first electrically conductive area and/or the electrically conductive pattern.

Further characteristic features in which information may by encoded are the angles which are enclosed by the touch points on the front side of the information carrier. Preferably, an angle is defined by the position of at least three touch points. As an example, an angel α is assigned to a touch point A. The centre of touch point A is virtually connected to the centres of touch points B and C by virtual lines forming angle legs which meet in the centre of touch point A. These legs are preferably referred to as AB and AC. It is preferred that angle legs AB and AC enclose the angle α. Analogously, angles α (assigned to touch point B) and γ (assigned to touch point C) may be construed, angle β being enclosed by angle legs BA and BC and angle γ being enclosed by angle legs CA and CB. Preferably, the size of the angles depends on the position of the touch points so that the angels may advantageously be used in order to encode information.

In the preferred embodiment of the invention, where the sub-areas of the first electrically conductive area and the electrically conductive pattern are arranged congruently or substantially congruently on either side of the information carrier, the information encoded by the touch points on the A-side of the information carrier is copied to the electrically conductive pattern on the B-side. In the context of the present invention, this means that the sub-areas of the electrically conductive pattern on the B-side of the information carrier encode preferably the same information as the sub-areas of the first electrically conductive area, i.e. the touch points. This surprising effect can be achieved by the inventive built up of the information carrier, in particular by the congruent or substantially congruent arrangement of the sub-areas of the first electrically conductive area and the electrically conductive pattern. In the context of the present invention, it is preferred that the sub-areas of the electrically conductive pattern on the B-side encode the same information as the touch points present on the A-side of the information carrier.

In one preferred embodiment, the sub-areas are arranged congruently on the front side and the back side of the information carrier. That means in the context of the present invention that the sub-areas of the first electrically conductive area and the sub-areas of the electrically conductive pattern are identical in terms of their number, shape, size, dimensions, position on the information carrier and distance to each other.

In another preferred embodiment the sub-areas are arranged substantially congruently. In the sense of the present invention, the term “substantially congruent” means that two sub-areas share the same geometric center of area. By this preferred built up, the geometric center of the sub-areas of the electrically conductive pattern are allocated in the same way as the geometric center of the electrically conductive sub-areas of the first electrically conductive area on the A-side. That means in the context of the present invention that their position on the information carrier and distance of the sub-areas to each other is identical based on the geometric center. In this embodiment of the invention, it is preferred that the number of sub-areas is identical on front side and back side of the information carrier. An example for substantially congruent sub-areas of the first electrically conductive area and the electrically conductive pattern may be an information carrier having circular touch points on the front side and sub-areas of the electrically conductive pattern on the back side which have the shape of flowers, doughnuts, stars, clouds and the like or any combination thereof. In this example, the number of touch points on the front side equals the number of sub-areas of the electrically conductive pattern on the back side of the information carrier. Furthermore, the positions of the sub-areas of the first electrically conductive area and the electrically conducive pattern on the substrate and distances of the sub-areas to each other is identical based on the geometric center.

It was totally surprising that the preferred built up of the information carrier where the sub-areas of the first electrically conductive area and the sub-areas of the electrically conductive pattern are arranged substantially congruently allows copying the information encoded by the sub-areas of the first electrically conductive area to the sub-areas of the electrically conductive pattern in the same way as if the sub-areas were arranged congruently to each other.

By sharing the same geometric center, the conductive pattern on the back side preferably encodes the same information as the touch points on the front side of the information carrier, wherein the information is particularly characterized by the number of touch points, the distances of the touch points to each other and/or the allocation and/or arrangement on the information carrier. Advantageously, this preferred built up allows for the design of information carriers with a higher flexibility. Surprisingly, sub-areas of the pattern on the B-side of the information carrier may be for example be designed differently to the sub-areas of the first electrically area on the A-side.

Another advantage may be found therein that is becomes possible to overprint the A-side of the information carrier, thereby hiding the complete code pattern. This surprising advantage allows for security applications, while the conductive pattern on the B-side will still be visible.

It is preferred that the first electrically conductive area on the front of the information carrier and the electrically conductive pattern on the B-side are connected galvanically by at least one via comprising a bore hole. According to the present invention, a via (vertical interconnect access) is an electrical and/or galvanic connection between electrically conductive elements on either side of an information carrier. It is preferred that the via goes through the substrate connecting the sub-areas of the first electrically conductive area on the front side of the information carrier and the elliptical sub-areas of the electrically conductive structure, i.e. the electrically conductive pattern, on the back side of the information carrier. In the sense of the invention, the term “galvanic” represents an electrical connection based on the conductivity of the connecting material between the elements on either side of the information carrier. It is therefore preferred in the context of the present invention that the bore hole is filled with electrically conductive material.

It may also be preferred that the information encoded by the sub-areas of the electrically conductive pattern can be detected by placing the information carrier onto a touch screen wherein the information carrier faces the touch screen with its B-side.

In the context of the present invention, it is preferred that the electrically conductive pattern may be detected by a touch screen when a human user touches the second electrically conductive area of the electrically conductive layer which is synonymously be referred to as coupling area. Preferably, a touch screen may only detect the information encoded within the information carrier if an electrically conductive area, in particular the coupling area, is touched by said human user. It is therefore important to facilitate the accessibility of the coupling area in order to enable the detection of the electrically conductive pattern. This is advantageously achieved by the preferred built-up of the information carrier.

In conventional information carriers, the coupling area of the electrically conductive layer is touched by a human user, for example, by a finger of a human user causing a change in the electric properties of the electrically conductive layer, i.e. the potential, state of charge and/or the capacitance. This change may advantageously be transferred to the other components of the electrically conductive layer on the front side of the information carrier, preferably by the conductive traces. Thus, the components of the electrically conductive layer are advantageously rendered detectable by the touch of a human user. As the components of the electrically conductive layer are arranged in one plane on the front side surface of the substrate of the information carrier, the components of the electrically conductive layer have the same distance to the touch screen. Therefore, the components of the electrically conductive layer are detected by the touch screen with substantially the same impact of the first, second and third electrically conductive area.

In the context of the present invention, inventors have found that changes in electrical properties, e.g. a change in a state of charge, caused by the touch of a human user may be distributed within the electrically conductive layer and, in particular, transferred to the sub-areas of the electrically conductive pattern on the back side of the information carrier by means of the at least one via. The electrical and/or galvanic connection between the sub-areas on either side of the information carrier formed from the via surprisingly allows for the reading out of the information encoded within the sub-areas of the first electrically conductive area and/or the sub-areas of the electrically conductive pattern.

As described above, it is an object of the present invention to enhance the capacitive impact of the desired elements, i.e. the touch points, on the touch screen. It was totally surprising that such a strong enhancement may advantageously be achieved by the preferred built-up of the information carrier.

Since the sub-areas of the electrically conductive pattern on the B-side are congruent or substantially congruent to the touch points present on the A-Side of the information carrier, the information encoded is preferably the same. By means of the via, i.e. the galvanic and/or electrical connection of the sub-areas of the first electrically conductive area on the front side of the information carrier and the sub-areas of the electrically conductive pattern on the back side of the information carrier, the electrically conductive pattern is set on the same potential as the electrically conductive layer on the A-side. Thus, the components of the electrically conductive pattern become advantageously detectable by the capacitive touch screen.

Preferably, when the information carrier according to the present invention is placed on a touch screen so that the back side of the substrate faces the surface of the touch screen, the electrically conductive element that is detected by the touch screen with the strongest impact is the electrically conductive pattern on the back side of the information carrier. This is advantageously due to the distance of said pattern to the touch screen that is shorter than the distance of the components of the electrically conductive layer, which is arranged on the front side of the information carrier, wherein the front side of the information carrier faces away from the touch screen.

It came as a surprise that by means of the galvanic connection between the sub-areas on either side of the information carrier, i.e. the via, the impact of the touch points on the touch screen is enhanced compared to the impact of the second and third electrically conductive area, i.e. the conductive traces and the coupling area, which are not connected by means of vias to sub-areas of the electrically conductive pattern on the back side of the information carrier. The enhanced impact of the sub-areas of the first electrically conductive area on the touch screen compared to the conductive traces and the coupling area is advantageously due to the galvanic connection generated by the via which reduces the distance of the touch points to the touch screen by copying their information to the sub-areas of the pattern present on the B-side and, thus, enhancing the capacitive impact of said touch points on the touch screen (see formula A beneath).

By the advantageous virtue of this effect, the impact of the conductive traces and the coupling area on the touch screen and, consequently, the distortions and deviations which are caused by these necessary, but interfering elements, is significantly be reduced to an extent that was not predictable for a person skilled in that art. Thus, the information encoded within the information carrier may be detected and/or read out by the touch screen with an enhanced preciseness and an improved resolution that was not to be expected. In particular, the deviations known from state of the art information carriers caused by the conductive traces, which may shift the center of the detected touch points, is surprisingly reduced to a minimum. Thereby, the tolerances and minimal distances between similar touch structures may be reduced significantly, surprisingly leading to a more precise, reliable and faster detection process.

The via can be formed by generating a bore hole in the electrically non-conductive substrate of the information carrier. In a preferred embodiment of the invention, this can be realized by mechanical drilling, laser drilling, perforation or laser cutting. A person skilled in the art knows how to generate a hole in a substrate in a way that an electrical connection can be realized between two electrically conductive elements placed on either side of such substrate. Preferably, the via is a through hole via leading from the front side of the substrate to the back side without interruption. Furthermore, it is preferred that the substrate is a mono-layer substrate and that the through hole has a substantially straight tubular shape that does not have any offsets and deviations from the substantially straight tubular shape. It is preferred that the term “tubular” comprises tubes with all conceivably surface areas, for example circular, elliptical, triangular, rectangular, squared surface areas, without being limited to this group. Preferably, the tubular shaped via has a virtual middle axis standing essentially perpendicular to the front side and the back side surface of the substrate of the information carrier. It is preferred that the tubular shaped via forms the shortest connection between the opening of the bore hole on the front side and the opening of the bore hole on the back side of the substrate of the information carrier.

In the sense of the present invention, the first electrically conductive area consists of several sub-areas which correspond to the touch points known from the prior art. These first electrically conductive areas or touch points are connected to each other by the third electrically conductive area which may also comprise several sub-areas which can be referred to as conductive traces. They connect at least some of the touch points with each other and/or to the second electrically conductive area which can be referred to as a coupling area which allows for coupling in a capacitance of a human user to an information carrier. The second and third electrically conductive areas corresponding to conductive traces and a coupling area known from the prior art represent the necessary, but interfering elements of the information carrier. It is preferred that they are not detected by a touch screen, nor trigger events on it. Preferably, the function of the conductive traces is to galvanically and/or electrically connect the touch points to each other and/or to the coupling area. It is preferred that the coupling area may be touched by a human user, in particular the finger of said user, in order to change the electric properties, in particular the capacitance and/or the potential of the electrically conductive layer of the information carrier.

In a preferred embodiment of the invention, electrical charges are transferred between a conductive object that touches the second electrically conductive area, causing a local change in a state of charge of the electrically conductive layer which is transferred from at least one sub-area of the first electrically conductive area to at least one sub-area of the electrically conductive pattern by means of at least one via.

The term “conductive object” preferably refers to any conductive object, but may in particular refer to a finger of a human user. Therefore, the terms “user” and “conductive object” are used synonymously in the description of the present invention.

Preferably, the information encoded by the characteristic features of the first electrically conductive area and the electrically conductive pattern may advantageously be detected by a touch screen by the touch of the human user as electric charges are exchanged between the user, the electrically conductive layer which is arranged on the front side of the information carrier and the sub-areas of the electrically conductive pattern, being connected galvanically and/or electrically by means of a via to the touch points. By the electrical or galvanic connection between said sub areas on either side of the information carrier, the electrical charges are transmitted through the via to the electrically conductive pattern on the B-side. Thereby, the electrically conductive pattern may be detected by a capacitive touch screen.

Preferably, the coupling area is an area of generally conductive material on the information carrier. It is electrically or galvanically linked via conductive traces to at least one of the sub-areas of the first conductive area representing the touch points such that the linked areas are preferably set on the same electric potential as the coupling area. The coupling area is preferably easily to access by a user in order to transfer the potential of the human user to the coupling area. Preferably, the coupling area does not need to be a closed area, but may comprise a grid of conductive lines or an array of electrically connected structures.

The coupling area may for example be used in such a way that a human user places his finger on the coupling area. Thus, the electrically conductive areas which are electrically or galvanically linked to this coupling area will have substantially the same electric potential as the user's finger. This may be advantageous, since touch screens are commonly designed to work with a typical capacity of a human user.

The coupling area need not necessarily be directly contacted by the user's finger, since the finger being in close proximity to the coupling area may sufficiently influence the capacity of the coupling area to achieve the desired effect.

It may be preferred that the coupling area is not placed on the top of the touch screen, but rather beneath the touch screen. It may also be preferred for some applications, that the coupling area is placed on the touch screen and touched by the user. In this case, the coupling area additionally serves as a touch point and is also detected by a touch screen and triggers events on a touch screen.

By connecting the touch points and the elliptical sub-areas of the electrically conductive pattern which are placed on the back side of the information carrier by virtue of a via, the capacitance of the user is preferably coupled into the electrically conductive pattern of the B-side of the information carrier. When a user touches a coupling area, a local change in capacitance is caused which is transmitted to the touch points via the third electrically conductive areas representing conductive traces. As the touch points are linked galvanically to the elliptical sub-areas of the electrically conductive pattern on the back side of the information carrier, the capacitance of the user can be detected by a touch screen when an information carrier is brought into contact with a touch screen facing it with the back or B-side on which the pattern is present.

If an information carrier is brought into contact with a touch screen facing the touch screen with its back side, the touch screen receives the strongest capacitive signals from the electrically conductive pattern on the B-side of the information carrier.

Regarding the electrically conductive elements of the information carrier, the touch screen essentially detects only the real, physical positions of the touch points, but not the conductive traces and the coupling areas. This is advantageously due to the galvanic connection formed by the vias between the sub-areas of the electrically conductive pattern and the touch points on the A-side. In the sense of the present invention, the expression that the touch screen essentially detects only the touch points means, that the capacitive impact of the necessary, but interfering elements, i.e. the conductive traces and the coupling area, is reduced by two orders of magnitude in comparison to the capacitive impact of the elliptical sub-areas of the conductive pattern connected to the touch points of the first electrically conductive area on the A-side. It came as a surprise that an information carrier can be provided where the difference between the capacitive impact of touch points on the one hand and the capacitive impact of the coupling area and the conductive traces on the other hand may differ by two orders of magnitude as can be seen from the calculations below.

The capacitive impact can be described by using the formula for the capacitance C of a parallel-plate capacitor:

$$C = {ɛ}_{0} \cdot {ɛ}_{r} \cdot \frac{A}{d} \qquad ( formula A )$$

C . . . capacitance
ε₀ . . . vacuum permittivity (ε₀=8.8541878176·10⁻¹² F/m)
εᵣ . . . relative permittivity of the material
A . . . area of the parallel-plate capacitor
d . . . distance of the plates in the parallel-plate capacitor

As ε₀ is a constant, the capacitance C can be increased by increasing the relative permittivity εᵣ or the area A or by decreasing the distance d. In the context of the present invention, the area A refers to the dimension of the touch points and is constant as the touch points have a constant radius. In the context of the present invention, the distance d refers to the distance between an electrically conductive element to be detected by a touch screen and the touch screen itself. In the prior art, this distance d is constant for all electrically conductive parts of an information carrier as they form a single layer having the same distance to a touch screen. By placing an electrically conductive pattern on the back side of the information carrier and galvanically connect this pattern to the touch points and by detecting the information career facing the touch screen with its back side, the effective distance d_{eff} of the touch points to the touch screen could be reduced by two orders of magnitude. In the sense of this invention, the effective distance d_{eff} of the touch points corresponds to the distance between the touch screen and the elliptical sub-areas of the electrically conductive pattern on the back side of the information carrier, as they are galvanically linked to the touch points by the vias. By connecting only the touch points to the elliptical sub-areas of the electrically conductive pattern of the information carrier, only the distance of the touch points to the touch screen is reduced to the effective distance d_{eff}. The necessary, but interfering elements, i.e. the conductive traces and the coupling area, are not linked galvanically with the elliptical sub-areas. That is why they maintain their real, physical distance to the touch screen which inter alia depends on the thickness of the information carrier. By means of the vias, the touch points on the one hand and the conductive traces and the coupling area on the other hand are allocated different distances to the touch screen. This leads to different capacities C or capacitive impacts according to formula A generating the desired capacitive contrast according to the object of the present invention. The decrease of the distance d leads to an increase of the capacitive impact of the touch points compared to the necessary, but interfering elements by a factor of about 100. It was totally surprising that such a large increase of the capacitive contrast may be achieved enabling for a much higher reading preciseness of the real positions of the touch points. This allows for a significantly more precise detection of the information carrier and for an unexpected higher level of security in the use of the information carrier according to the present invention.

It may be preferred that the information carrier according to the present invention is connected to an object or that the object itself serves as a substrate. An object in the sense of the present invention is in particular a thing, an article or an entity. In a most preferred embodiment of the present invention, the information carrier is connected to or serves as a part of a package. The attachment or application can be effected, for example, self-adhesively, or by means of other known joining technologies or auxiliaries. It is also preferred that the electrically conductive areas and patterns are printed directly on the object.

In another preferred embodiment of the invention, the information carrier comprises one to ten, preferably two to seven and most preferably three to five vias per one sub-area of the first electrically conductive area and one sub-area of the electrically conductive pattern, i.e. a touch point and an elliptical sub-area of the electrically conductive pattern on the back side of the information carrier. It has been shown that theses number ranges provide the best results regarding an enhanced capacitive contrast between the desired and the necessary, but interfering elements present on the front side of the information carrier. They have shown to be a suitable compromise in the sense that a larger amount of vias creates larger production costs, but a minimal number of vias is necessary to ensure the desired enhanced contrast.

In another preferred embodiment of the invention, the electrically conductive areas on the front side and the electrically conductive pattern on the back side of the information carrier are formed from electrically conductive materials comprising metal layer, layer containing metal particles or nanoparticies, containing electrically conductive particles, in particular carbon black, graphite, graphene, ATO (antimony tin oxide), electrically conductive polymer layer, in particular Pedot:PSS (poly(3,4-ethylenedioxythiophene) Polystyrene sulfonate), PANI (polyaniline), polyacetylene, polypyrrole, polythiophene and/or pentacene or any combination of these. These materials have shown an electric conductivity that allows for being detected by a touch screen when a coupling area is touched by a human user and the capacitance of that user is transferred to the electrically conductive elements which are linked by the conductive traces and the vias. Furthermore, elements consisting of these materials enable for galvanically or electrically connecting electrically conductive areas on the information carrier.

It was totally surprising that such a large number of different materials can be used to create the electrically conductive elements of the information carrier, giving way to a great flexibility regarding the production process of the conductive elements. What is more, it is easy to adapt an information carrier according to the present invention to certain applications where certain pre-defined features have to be met.

In another preferred embodiment of the invention, the bore hole for the via has a diameter of 0.1 to 2 mm, preferably 0.1 to 1 mm and most preferably between 0.1 to 0.6 mm. These dimensions have shown to achieve the best results regarding the desired enhanced capacitive contrast between the desired and the necessary, but interfering elements placed on the front side of the information carrier. Surprisingly, the dimension of the vias may be adapted to a degree so that preferably three to five vies may be placed between one touch point and a congruent or substantially congruent sub-area of the electrically conductive pattern in order to achieve a high quality conductive connection between the two elements which is characterized by a surprisingly good conductivity.

In another preferred embodiment of the invention, the electrically conductive areas, in particular the touch points, the conductive traces and the coupling area, and the elliptical sub-areas of the electrically conductive pattern are printed by additive printing methods selected from a group comprising offset-printing, flexo-printing gravure-printing, screen-printing, pad printing and/or digital-printing. The term “digital printing” comprises printing methods like inkjet printing, thermal transfer printing, dye-sublimation printing and xerography which is also known as laser printing.

It was totally surprising that common additive printing technologies can be used to produce the electrically conductive elements on either side of the information carrier with such a high precision and reproducibility. By using the preferred printing technologies, a cost efficient, but highly accurate information carrier can be provided and the production of this information carrier can easily be adapted to different needs according to different applications.

It is most preferred to produce the electrically conductive elements of the information carrier by screen-printing. Using that kind of printing technology generates large thicknesses of the printed layer on the substrate, thus leading to a relative large amount of electrically conductive material present on the substrate of the information carrier which can be used both to form the electrically conductive elements and to fill the bore holes for the vias between the touch points and the congruent or substantially congruent elliptical sub-areas of the electrically conductive pattern of the information carrier.

In another preferred embodiment of the invention, the electrically conductive areas and the electrically conductive pattern are applied to the substrate of the information carrier by a foil transfer process, preferably a hot stamping method and/or a cold foil transfer method. In the sense of the present invention, a foil transfer process represents a process by the virtue of which a metallic foil layer can be pressed on a substrate which is covered with an adhesive layer at those spots where the metallic foil layer is supposed to be placed. The metallic foil layer sticks to the adhesive spots forming a continuous, fixed connection between the adhesive layer and the metallic foil layer. In the process of hot stamping, pressure and heat are used to apply the metallic foil layer to the substrate. The above-mentioned foil transfer methods are preferred as these technologies are very flexible, easy to adapt to new applications and cost efficient. If the electrically conductive elements are applied to the substrate by a foil transfer process, it is necessary to fill the bore hole by the use of a dispenser as will be explained below.

It can also be preferred to apply the electrically conductive areas and the electrically conductive pattern with a chemical or physical vapor deposition method. Vapor deposition processes represent chemical processes used to produce high-purity, high-performance solid materials. In the chemical deposition process, the substrate is preferably exposed to one or more volatile precursors, which react and/or decompose on the substrate surface to produce the desired deposit Physical vapor deposition describes a variety of vacuum deposition methods used to deposit thin films by the condensation of a vaporized form of the desired film material onto a substrate. Physical vapor deposition preferably involves purely physical processes such as high-temperature vacuum evaporation with subsequent condensation, or plasma sputter bombardment rather than involving a chemical reaction at the surface to be coated as in chemical vapor deposition.

In another preferred embodiment of the invention, the electrically conductive elements can be applied to the substrate by a sputtering process. In the context of the present invention, it Is preferred that sputtering is a process where atoms are ejected from a solid target material due to bombardment of the target by energetic particles. It is driven by momentum exchange between the ions and atoms in the materials, due to collisions.

Layers of electrically conductive material applied by the above-mentioned deposition methods are advantageous as they are harder and more corrosion resistant than coatings applied by other processes known to a person skilled in the art. Most coatings have high temperature and enhanced impact strength, good abrasion resistance and are so durable that additional protective coatings are not necessary. Chemical and physical vapor deposition methods enable for a large variety of different materials to be applied on a substrate. Furthermore, they are environmentally friendly compared to traditional coating processes such as electroplating and painting.

In case that the electrically conductive areas and the electrically conductive pattern are deposited by the above-mentioned foil transfer processes or vapor deposition methods, the filling of the bore holes forming the vias is realized by the use of a dispenser. In the sense of the invention, a dispenser is a technical installation to apply electrically conductive material to a desired spot on the substrate of the information carrier, in particular the bore holes later forming the vias which connect the touch points and the circular sub-areas of the electrically conductive pattern. The use of a dispenser is particularly preferred when a large amount of electrically conductive material is supposed to be applied to the bore holes, thus enlarging the conductivity of the via and further enhancing the capacitive impact of the touch points compared to the necessary, but interfering elements.

In another preferred embodiment of the invention, the electrically conductive areas and the electrically conductive pattern consist of the same electrically conductive material and the bore holes are filled with the material of the electrically conductive areas and the electrically conductive pattern. It was totally surprising that not only the planar elements on the front and on the back side of the information carrier can be manufactured by a printing process, but also the filling of the bore hole forming the via and the electric and galvanic connection between the elliptical sub-areas of the electrically conductive pattern and the congruent or substantially congruent touch points. It represents an advantage of the present invention that the via and its filling can be realized by an inline printing process, as costs are reduced by the use of such a production method. Furthermore, the information carrier according to the invention can still be produced in a mass production process, even though the via is added to the information carriers known from the prior art. This allows for a simple production in a cost efficient manner without having to adapt the production processes used for the information carriers known from the prior art. Another advantage of the invention is that less excess material is wasted in the production process.

It can also be preferred to fill the bore holes with an electrically conductive material which is different from the material used for the electrically conductive elements on the front side and the back side of the information carrier. This is particularly advantageous if the conductive elements and the filling of the bore holes shall have different properties regarding their conductivity.

In another preferred embodiment of the invention, the filling of the bore hole is executed through job steps selected from a group comprising

i. printing the front side of the information carrier and/or

ii. printing the back side of the information carrier and/or

iii. filling of the bore hole by means of a dispenser with an electrically conductive material.

It is preferred that the information carrier is realized by first printing the front or A-side of the information carrier with the touch points, conductive traces and coupling area forming the electrically conductive layer, and then printing the back or B-side of the information carrier with the electrically conductive pattern. It can also be preferred to print the back side first and the front side afterwards. In case that foil transfer methods or vapor depositions methods are used to produce the electrically conductive elements of the information carrier, the bore holes are filled with an additional job step comprising the use of a dispenser to apply the electrically conductive material to the bore holes.

In another preferred embodiment of the invention, the electrically non-conductive substrate has a thickness of 20 to 2.000 μm, preferably 50 to 1.000 μm and most preferably 150 to 500 μm. As described above, the capacitive contrast between the touch points on the one hand and the conductive traces and the coupling area on the other hand are due to the different distances they are allocated. The effective distance of the touch points corresponds to the distance between the touch screen and the elliptical sub-areas of the electrically conductive pattern which the touch points are galvanically linked to by the vias, whereas the distance of the conductive traces and the coupling area is the real, physical distance of the conductive traces and the coupling area to the touch screen. This real, physical distance depends on the thickness of the substrate.

These ranges of thicknesses have shown to generate the largest enhanced capacitive contrast between the touch points and the necessary, but interfering electrically conductive elements. It was totally surprising that substrates having these ranges of thicknesses can be applied with common via technology leading to the desired effect of the enhanced capacitive contrast.

Furthermore, in another preferred embodiment of the invention, the electrically non-conductive substrate consists of a flat, flexible, non-conductive material, in particular paper, cardboard, plastic, wood-based material, composite, glass, ceramic, textile, leather or any combination thereof. These materials have shown to be particularly suitable for being provided with bore hole to form the vias which lead to the enhanced capacitive contrast which is the object of the present invention.

In accordance with another preferred aspect of the invention, the invention relates to a method for the manufacture of an information carrier according to the above-mentioned features of the information carrier, comprising the following steps
a. providing an electrically non-conductive substrate and
b. generating a bore hole in the electrically non-conductive substrate by mechanical drilling, laser drilling, perforation and/or laser cutting and
c. applying an electrically conductive material for the electrically conductive areas on the front side of the information carrier and
d. applying an electrically conductive material for the electrically conductive, pattern on the back side of the information carrier,

wherein at least one bore hole is filled with the electrically conductive material,
i. wherein the filling of the at least one bore hole is executed by one or more of the steps c and/or d, wherein conductive ink is applied on the substrate or
ii. wherein the filling of the at least one bore hole with the electrically conductive material is executed in an additional step by the use of a dispenser, if the electrically conductive areas and the electrically conductive pattern are applied by a foil transfer process or by a chemical vapor deposition method, a physical vapor deposition method and/or a sputtering process on the electrically non-conductive substrate.

It is also preferred that the front and the back side of the information carrier are overprinted by opaque ink or a varnish layer. Overprinting the electrically conductive elements on both sides of the information carrier can be advantageous in order to protect the electrically conductive elements and to preserve their functionality. In some applications, it may also be desired to hide the electrically elements from sight. In other applications, such overprinting may not be desired in order to highlight the technical character of the information carrier obtained by the method for the manufacture according to the present invention. In a further embodiment it may be preferred to overprint only one side of the information carrier, the electrically conductive pattern present on the back side and/or the conductive layer present on the front side.

It was totally surprising that an information carrier according to the present invention having a more complex build-up as the information carriers which are known in the prior art can be produced by such a simple, cost efficient. The production can preferably be realized inline, by one production process.

It is preferred that the electrically conductive elements are first applied on the front side of the information carrier and then on the back side. It can also be preferred to apply the electrically conductive elements first on the back side and then on the front side of the information carrier. This means that steps c. and d. of the method for the manufacture of an information carrier can by changed.

If the electrically conductive elements are applied by printing techniques, the bore holes forming the vias are filled by printing the front and back side of the information carrier. This is done in a most preferred manner by using screen-printing methods. These have shown to be particularly suitable as a relatively large amount of electrically conductive printing material is brought on top of the substrate, thus being available for the filling of the bore holes.

In case the electrically conductive elements are applied by foil transfer methods or vapor deposition methods, the bore holes are filled in an additional job step, i.e. filling the bore holes by use of a dispenser. This means that a dispensing device is used to locally apply the electrically conductive material into the bore holes, thus forming the vias.

Another preferred aspect of the invention refers to a method for detecting an information carrier according to the present invention by a touch screen wherein a touch of a user on the second electrically conductive area causes a local change in capacitance and/or potential of the electrically conductive layer.

In another preferred embodiment of the method, the back side of the information carrier is brought in contact with the touch screen.

The back side of the information carrier preferably comprises the electrically conductive pattern. This pattern consists of several elliptical sub-areas which are galvanically and/or electrically linked to the congruent or substantially congruent touch points on the front side of the information carrier by the vias. The touch points on the front side of the information carrier are partially connected with each other by conductive traces, so that every touch point is directly or indirectly linked to a coupling area. In the sense of the present invention, the expression “directly linked” means that a touch point is linked to a coupling area by only a conductive trace. “Indirectly linked” means that a touch point is linked to a coupling area by more than one conductive traces and at least one additional touch point.

When a user touches the coupling area on the front side of the information carrier, the coupling area, the conductive traces and the touch points are preferably set onto the potential of the user. In other words, the touch of the user on the second electrically conductive area causes a local change in capacitance and/or potential of the electrically conductive layer which is transferred to the electrically conductive pattern on the back side of the information carrier. Advantageously, this change in electrical properties due to the touch of the user can be detected by the touch screen.

If an information carrier according to the prior art was brought into contact with a touch screen, the touch screen would detect all the electrically conductive elements of the information carrier equally strong. The touch screen would not “see” a difference between the desired, i.e. the touch points, and the necessary, but interfering elements, i.e. conductive traces and coupling area. This identical detection would be the result regardless of which side of the information carrier faces the touch screen.

According to the preferred method for detecting the information carrier, the information carrier is brought in contact with the touch screen in a manner that the back side comprising the electrically conductive pattern faces the touch screen. As the sub-areas forming this pattern are galvanically or electrically linked only to the touch points carrying the user's potential and capacitance, essentially only these sub-areas may be detected and evaluated by the touch screen. Using figurative language, one could say that a capacitive copy of the touch points being placed on the front side of the information carrier is taken and reproduced to the back side of the information carrier, thereby showing only the desired elements, but not the necessary, but interfering elements.

The touch screen is now capable of detecting essentially only the desired pattern of touch points representing their positions that are not distorted by the interfering elements. The touch screen also “sees” the interfering elements placed on the front side of the information carrier, but the distance d between the necessary, but interfering elements is much larger than the effective distance de between the touch points and the touch screen, as the touch points are represented on the back side of the information carrier by the elliptical sub-areas of the electrically conductive pattern. Thus, the effective distance d_{eff} for the touch points is the distance between the elliptical sub-areas of the electrically conductive pattern and the touch screen. This effective distance d_{eff} is much smaller than the real distance between the touch points, conductive traces and coupling areas on the front side of the information carrier, all having the same distance to the touch screen. According to the formula

$$C = {ɛ}_{0} \cdot {ɛ}_{r} \cdot \frac{A}{d}$$

for the capacitance C, a reduced distance d, as achieved for the touch points by replacing the distance d by the effective distance do, leads to an increased capacitance C and an increased capacitive impact of the touch points on the touch screen.

The effect of the enhanced capacitive impact is illustrated in the following example: Given the vacuum permittivity ε₀=8.85·10⁻¹² F/m, the relative permittivity εᵣ=3 for card board material of the electrically non-conductive substrate of the information carrier, and the area A=50.3·10⁻⁶ m² as the dimension of an average touch point, the capacitance C or the capacitive impact of the necessary, but interfering elements on the front side of the information carrier can be calculated to be

$$C = 8 \text{,} 85 \cdot {10}^{- 12} \cdot \frac{F}{m} \cdot 3 \cdot \frac{50 \text{,} 3 \cdot {10}^{- 6} {m}^{2}}{300 \cdot {10}^{- 6} m} = 4 \text{,} 45 \cdot {10}^{- 12} F$$

if the information carrier is detected from the back side of the information carrier and the distance d is supposed to be d=300 μm corresponding to an average thickness of the substrate material of the information carrier. If, instead of the distance d, an effective distance d_{eff} representing the thickness of the overprinting ink or varnish is used for the touch points and the corresponding sub-areas of the conductive pattern on the B-side which can be approximated to be d_{eff}=3 μm, the capacitance C or the capacitive impact changes to

$$C = 8 \text{,} 85 \cdot {10}^{- 12} \cdot \frac{F}{m} \cdot 3 \cdot \frac{50 \text{,} 3 \cdot {10}^{- 6} {m}^{2}}{3 \cdot {10}^{- 6} m} = 4 \text{,} 45 \cdot {10}^{- 10} F$$

which is two orders of magnitude larger than the capacitance C which was calculated before. It is noted that in this case, εᵣ, which is equal to 3 and lies advantageously in the same range of magnitude as the relative permittivity of the cardboard material of the electrically non-conductive substrate, corresponds to the relative permittivity of the ink or the varnish that is used to overprint the electrically conductive elements on the information carrier. It is also noted that the same area A was chosen for both examples in order to be able to compare the resulting capacitances to each other. Also the first equation applies to the interfering, but necessary elements, their size may also be approximated to be A=50.3·10⁻⁶ m². From the result of the calculation above, it can be seen that by connecting the touch points galvanically to the elliptical sub-areas of the electrically conductive pattern and by detecting the information carrier with the back side facing the touch screen, the capacitive impact of the desired electrically conductive elements, i.e. the touch points, can be increased by a factor of about 100.

In another preferred aspect, the invention relates to the use of an information carrier wherein the sub-areas of the electrically conductive pattern cause a local change of capacitance on a touch screen by bringing into contact the information carrier and a touch screen.

A touch screen comprises in particular an active circuit. In the sense of the present invention, this circuit is referred to as touch controller. It is connected to a structure of electrodes. These electrodes are usually divided into transmitting and receiving electrodes. The touch controller preferably controls the electrodes in such a way that a signal is transmitted between in each case one or more transmitting electrodes and one or more receiving electrodes. If the touch screen is in a state of rest, this signal is constant. The purpose of a touch screen is in particular the detection of fingers and their position on the surface of the touch screen. By bringing into contact a finger of a user and the surface of a touch screen, the above-mentioned signal is changed as the touch controller detects a change in capacitance in its vicinity. The signal is usually diminished, because the finger takes up part of the signal from the transmitting electrode and only a reduced signal reaches the receiving electrode.

In the present invention, it is now made use of the conductivity of the electrically conductive elements on the front side of the information carrier and the conductivity of the pattern on the back side of the information carrier. If, Instead of a finger, an information carrier comprising electrically conductive elements is brought into contact to a touch screen, these conductive elements cause preferably the same effect as a finger, if a coupling area is touched by a user. This desired effect is a change in capacitance which can be detected by the touch controller of the touch screen. As certain desired electrically conductive areas, i.e. the touch points, are additionally linked to elliptical sub-areas of an electrically conducting pattern on the other side of the information carrier, their capacitive impact is enhanced compared to the capacitive impact of the necessary, but interfering elements, i.e. the conductive traces and the coupling area.

By virtue of the present invention, the touch screen essentially “sees” only the pattern formed by the elliptical sub-areas interacting with the touch points. Preferably, these elliptical sub-areas replicate the arrangement or the properties of fingertips. Replicating the arrangement or the properties of a finger tip means, in the sense of the invention, to execute an input to a touch screen just like a finger, i.e. causing a local change in capacitance which can be detected by the touch controller of the touch screen. It is a well-known fact for a person skilled in the art that an input can be executed on a touch screen with one or more fingers.

The properties of a fingertip that are supposed to be imitated by the touch points comprise their electrical properties, such as their conductivity, and/or additional properties, such as shape, size, dimension and/or the distance from the touch screen. It was totally surprising that these properties can be used in order to provide an information carrier with an enhanced capacitive impact of the desired elements compared to the impact of the necessary, but interfering elements.

The change of capacitance on the touch screen is caused by bringing into contact the touch screen and the information carrier according to the present invention. Preferably, this contact is a static and/or dynamic contact. In the sense of the invention, a static contact is a contact where both the touch screen and the information carrier are in rest. A dynamic contact refers to a contact where at least one of the two devices, i.e. touch screen and information carrier, is in motion.

### BRIEF DESCRIPTION OF THE DRAWINGS

These and other objects, features and advantages of the present invention will best be appreciated when considered in view of the following detailed description of the accompanying drawings:

FIG. 1 shows a side view of a preferred information carrier according to the present invention.

FIG. 2 shows a side view of a preferred information carrier when brought in contact with a touch screen for reading out the information carrier.

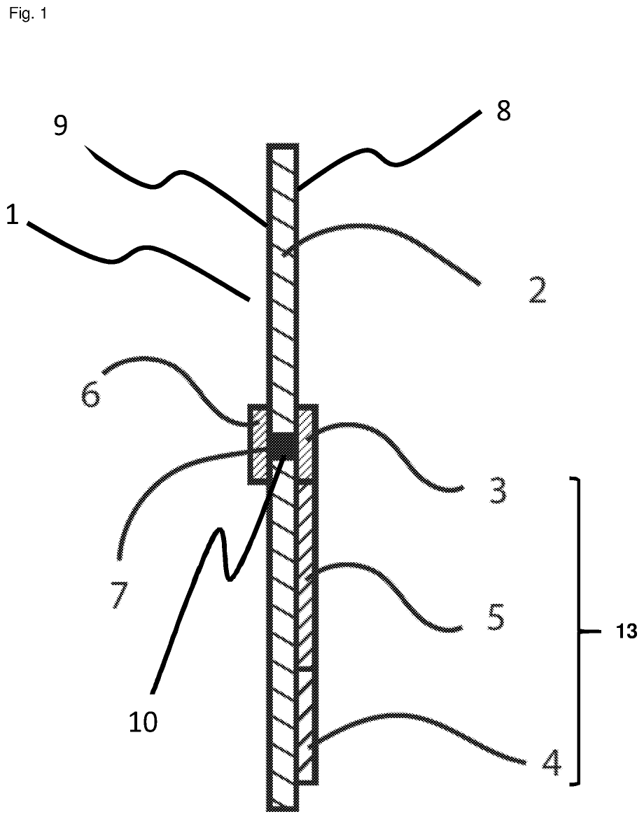

FIG. 1 shows a side view of a preferred information carrier (1) according to the present invention. The information carrier (1) consists of an electrically non-conductive substrate (2) having a front side (8) and a back side (9). On the front side (8), the information carrier (1) comprises electrically conductive areas (3, 4, 5).

In the context of the present invention, these electrically conductive areas (3, 4, 5) are referred to as first (3), second (4) and third electrically conductive area (5). They correspond to the components of a touch structure known from information carriers described in the prior art. In particular, the first electrically conductive area (3) corresponds to the touch points known from the prior art. In the context of this invention, the touch points are referred to as desired electrically conductive elements as they are supposed to trigger events on a touch screen (12) and the position of the first electrically conductive area (3) detected by the touch screen (12) is supposed to correspond to the real, physical positions of the touch points on the information carrier (1). In the prior art, distortions or deviations between the positions of the touch points (3) detected by the touch screen (12) and the real, physical positions of the touch points are caused by necessary, but interfering elements.

In the context of the present invention, these necessary, but interfering elements correspond to the second (4) and third (5) electrically conductive area placed on the front side (8) of the information carrier (1). The third electrically conductive area consists of several sub-areas. In the context of the present invention, they can be referred to as conductive traces that connect the touch points (3), either among each other or to the coupling area (4). The second electrically conductive area (4) corresponds to the coupling area known from the prior art. The purpose of this coupling area is to couple in the capacitance of a human user to the electrically conductive elements of the information carrier (1). This is achieved by a human user touching the coupling area (4). The coupling area (4) and the touch points (3) are linked galvanically or electrically by the conductive traces (5).

In addition to the electrically conductive elements on the front side (8) of the information carrier (1), the information carrier (1) comprises an electrically conductive pattern on the back side (9) of the information carrier (1). This electrically conductive pattern (6) consists of several elliptical sub-areas. In a preferred embodiment of the invention, the sub-areas of the electrically conductive pattern (6) are of circular shape. It can also be preferred that the sub-areas do not have a circular shape but have the shape of flowers, clouds, doughnuts, biscuits, hearts, stars and the like. These sub-areas forming the electrically conductive pattern (6) on the back side on the information carrier (1) which is congruent or substantially congruent to the touch points (3) on the front side (8) of the information carrier (1). In the context of this invention, the term “congruent” means that the elliptical sub-areas and the touch points have the same shape, size and orientation and they are placed at the same position on the front side (8) and on the back side (9) of the information carrier (1). This congruency of the elliptical sub-areas (6) and the touch points (3) can clearly be seen from FIG. 1.

The term “substantially congruent” refers to an electrically conductive pattern which is preferably present on the back side of the information carrier according to the present invention and which consists of sub-areas which do not necessarily have an elliptical shape, but can be present as flowers, clouds, doughnuts, biscuits, hearts, stars and all shapes that may be desired for special applications. In this case, the sub-areas on the back side of the information carrier forming the electrically conductive pattern and the touch points on the front side of the information carrier are not congruent in the strictly mathematical sense of the term congruent as they may differ in shape and size. What they have in common is their geometric centers of area and a sufficiently large area where the vias can be applied on. Sub-areas and touch points which differ in shape and size have equal geometric centers of area are referred to as “substantially congruent” In the sense of the present application.

FIG. 1 also shows a via (7) which forms a galvanic connection between the touch points (3) and the elliptical sub-areas of the electrically conductive pattern (6). In FIG. 1, only one via (7) Is shown. It is preferred that one touch point (3) and one elliptical sub-area (6) are galvanically connected by 1 to 10, preferably 2 to 7 and most preferably 3 to 5 vias (7). A via (7) is formed by drilling a bore hole (10) into the electrically non-conductive substrate (2). This bore hole (10) is filled with the electrically conductive material which is used to form both the electrically conductive elements (3, 4, 5) on the front side (8) of the information carrier and the electrically conductive pattern (6) on the back side (9) of the information carrier (1). It is also possible to fill the bore hole with any other electrically conductive material. By being filled with electrically conductive material, a via (7) is capable of galvanically or electrically connecting the touch points (3) and the circular sub-areas (6) with each other.

If the electrically conductive elements on the front and the back side of the information carrier are printed on the electrically non-conductive substrate, the bore hole is filled by the ink applied to the information carrier through the printing method. In case that the electrically conductive elements are applied to the substrate of the information carrier by a foil transfer method or physical or chemical vapor deposition methods or a sputtering process, it has shown to be necessary to fill the bore hole by the use of a dispenser in an additional job step.

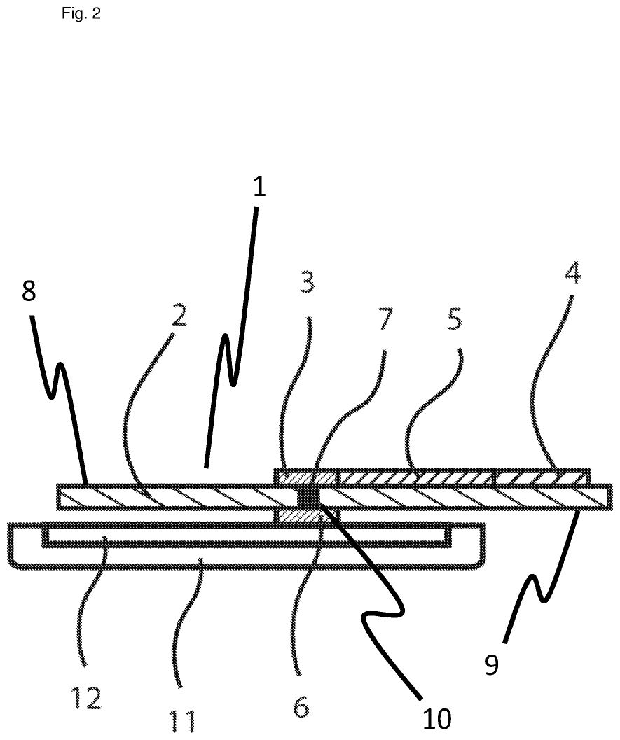

FIG. 2 shows a side view of a preferred information carrier (1) when brought in contact with a touch screen (12) for detecting the information carrier (1). The figure shows a device (11) with a touch screen (12). Furthermore, an information carrier (1) according to the present invention is shown in FIG. 2. The information carrier (1) is brought into contact with a touch screen (12) facing the touch screen (12) with the back side (9) of the information carrier (1). This means that the detection of the information carrier (1) is realized from the back side (9) of the information carrier (1). On the front side (8) of the information carrier (1), the touch points (3), the conductive traces (5) and the coupling area (4) are placed. The touch points (3) and the coupling area (4) are linked to each other by the conductive traces (5). These electrically conductive elements (3, 4, 5) on the front side (8) of the information carrier (1) form a touch structure known from the prior art. In the prior art, these electric conductive elements (3, 4, 5) have the same distance to the touch screen (12) as they are all placed within one single layer on the front side (8) of the information carrier (1). As these elements (3, 4, 5) all have the same distance to the touch screen (12), they all have the same capacitive impact on the touch screen (12). This can be deduced from formula A (see description).

It is the object of the present invention to generate a capacitive contrast between the desired touch points (3) on the one hand and the necessary, but interfering conductive traces (5) and coupling area (4). This aim is achieved by reducing the effective distance of the touch points (3) to the touch screen (12) and thus increasing the capacitive impact of the touch points (3) on the touch screen (12) compared to the capacitive impact of the conductive traces (5) and the coupling area (4).

In the prior art, the electrically conductive elements (3, 4, 5) on the front side (8) of the information carrier (1) are detected by a touch screen (12) when a human user touches the coupling area (4) of the information carrier (1). By the user's touch of the coupling area (4), the electrically conductive elements (3, 4, 5) of the front side (8) of the information carrier (1) are set to the same capacitive potential as the human user. In the present invention, the information carrier (1) additionally comprises vias (7) which connect the touch points (3) on the front side (8) of the information carrier (1) with the elliptical sub-areas of the electrically conductive pattern (6) on the back side (9) of the information carrier (1).

As the via (7) represents a galvanic or electrical connection between the touch points (3) and the pattern (6), the capacitance of the human user is transferred to the elliptical sub-areas (6). When the information carrier (1) according to the present invention is now brought into contact with a touch screen (12) facing the touch screen (12) with the back side (9) which comprises the elliptical sub-areas of the electrically conductive pattern (6), the distance to the elliptical sub-areas (6) is close to zero and is approximated in the present invention to be 3 μm. This length of 3 μm corresponds to the thickness of the opaque ink or the varnish layer which are used to overprint the electrically conductive elements on both sides of the information carrier. As the touch points (3) and the pattern (6) are linked galvanically with each other, this marginal, effective distance can also be assumed for the touch points (3).

As the conductive traces (5) and the coupling area (4) on the front side (8) of the information carrier (1) are not galvanically connected with any electrically conductive pattern (6) on the back side (9) of the information carrier (1), they keep their real, physical distance to the touch screen (12) which is defined by the thickness of the substrate (2). As a small distance d corresponds to an increased capacitance C according to formula A, the touch points (3) have an increased capacitive impact on the touch screen (12) compared to the conductive traces (5) and the coupling area (4). This difference in capacitance is referred to as capacitive contrast in the context of the present invention.

### LIST OF REFERENCE SIGNS

1 Capacitive, planar information carrier
2 Electrically non-conductive substrate
3 First electrically conductive area, i.e. touch point
4 Second electrically conductive area, i.e. coupling area
5 Third electrically conductive area, i.e. conductive trace
6 elliptical sub-area of electrically conductive pattern
7 via
8 front side of the information carrier
9 back side of the information carrier
10 bore hole
11 device with touch screen
12 touch screen
13 electrically conductive layer

1. A capacitive planar information carrier (1) comprising an electrically non-conductive substrate (2), an electrically conductive pattern (6) on a back side (9) of the information carrier (1) and a first, second and third electrically conductive area (3, 4, 5) forming an electrically conductive layer (13) on a front side (8) of the information carrier (1), wherein the electrically conductive pattern (6) and the first, second and third electrically conductive area (3, 4, 5) are formed from at least one sub-area respectively characterized in that
information is encoded by characteristic features of the first electrically conductive area (3), said information being copied to the electrically conductive pattern (6) by a congruent or substantially congruent arrangement of the electrically conductive pattern (6) and the first electrically conductive area (3),
wherein at least one sub-area of the first electrically conductive area (3) and at least one sub-area of the electrically conductive pattern (6) are galvanically connected by at least one via (7) comprising a bore hole (10), wherein the information is detectable by a capacitive touch screen (12), if the information carrier (1) faces the touch screen (12) with its back side (9).

2. The information carrier (1) according to claim 1, wherein electrical charges are exchanged between the second electrically conductive area (4) and a conductive object that touches said second electrically conductive area (4), causing a local change in a state of charge of the electrically conductive layer (13) which is transferred from at least one sub-area of the first electrically conductive area (3) to at least one sub-area of the electrically conductive pattern (9) by means of the at least one via (7).

3. The information carrier (1) according to claim 1, wherein the characteristic features are selected from the group comprising an overall shape of the first electrically conductive area (3) and/or the electrically conductive pattern (6), a distance of the sub-areas of the first electrically conductive area (3) and/or sub-areas of the electrically conductive pattern (6) to each other, an allocation of the sub-areas within the first electrically conductive area (3) and/or the electrically conductive pattern (6) and/or a number of sub-areas forming the first electrically conductive area (3) and/or the electrically conductive pattern (6).

4. The information carrier (1) according to claim 1, wherein the bore hole (10) is formed by mechanical drilling, laser drilling, perforation and/or laser cutting.

5. The information carrier (1) according to claim 1, wherein the information carrier (1) comprises one to ten vias (7) per one sub-area of the first electrically conductive area (3) and one sub-area of the electrically conductive pattern (6).

6. The information carrier (1) according to claim 1, wherein the electrically conductive areas (3, 4, 5) and the electrically conductive pattern (6) and the vias (7) comprise a layer selected from the group consisting of a metal layer, a layer containing metal particles or nanoparticles, a layer containing electrically conductive particles an electrically conductive polymer layer or any combinations thereof.

7. The information carrier (1) according to claim 1, wherein the bore hole (10) has a diameter of between 0.1 to 0.6 mm.

8. The information carrier (1) according to claim 1, wherein the electrically conductive areas (3, 4, 5) and the electrically conductive pattern (6) are printed by additive printing methods selected from the group consisting of offset-printing, flexo-printing, gravure-printing, screen-printing, digital printing and combinations thereof.

9. The information carrier (1) according to claim 1, wherein the electrically conductive areas (3, 4, 5) and the electrically conductive pattern (6) are applied by a foil transfer process.

10. The information carrier (1) according to claim 1, wherein the electrically conductive areas (3, 4, 5) and the electrically conductive pattern (6) are applied with a chemical or physical vapor deposition method or a sputtering process.

11. The information carrier (1) according to claim 1, wherein the electrically conductive areas (3, 4, 5) and the electrically conductive pattern (6) consist of the same material and the bore hole (10) is filled with an electrically conductive material.

12. The information carrier (1) according to claim 1, wherein a filling of the bore hole (10) is executed through job steps comprising
i. printing the front side (8) of the information carrier (1) and/or
ii. printing the back side (9) of the information carrier (1) and/or
iii. filling of the bore hole (10) by means of a dispenser with an electrically conductive material.

13. The information carrier (1) according to claim 1, wherein the electrically non-conductive substrate (2) has a thickness of 150 to 500 μm.

14. The information carrier (1) according to claim 1, wherein the electrically non-conductive substrate (2) comprises a flat, flexible, non-conductive material.

15. A method for the manufacture of an information carrier (1) according to claim 1, comprising the following steps
a. providing a electrically non-conductive substrate (2) and
b. generating the bore hole (10) in the electrically non-conductive substrate (2) by mechanical drilling, laser drilling, perforation and/or laser cutting and
c. applying an electrically conductive material for the electrically conductive areas (3, 4, 5) on the front side (8) of the information carrier (1) and
d. applying an electrically conductive material for the electrically conductive pattern (6) on the back side (9) of the information carrier (1),
wherein at least one bore hole (10) is filled with the electrically conductive material,
i. wherein a filling of the at least one bore hole (10) is executed by one or more of the steps c and/or d, wherein conductive ink is applied on the substrate (2) or
ii. wherein the filling of the at least one bore hole (10) with the electrically conductive material is executed in an additional step by the use of a dispenser, if the electrically conductive areas (3, 4, 5) and the electrically conductive pattern (6) are applied by a foil transfer process or by a chemical vapor deposition method, a physical vapor deposition method and/or a sputtering process on the electrically non-conductive substrate (2).
